(19) United States
(12) Patent Application Publication
(10) Pub. No.: US 2006/0231482 A1
(43) Pub. Date: Oct. 19, 2006

(54) Integrated waffle fluid filter apparatus and method

(76) Inventors: Ibrahim Khalil, Lake Barrington, IL (US); John G. Eleftherakis, Stillwater, OK (US); Abdul Karim Maoued, Stillwater, OK (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/366,662

(22) Filed: Mar. 3, 2006

Related U.S. Application Data
(63) Continuation-in-part of application No. 11/050,867, filed on Feb. 7, 2005.

(51) Int. Cl. B01D 24/00

(52) U.S. Cl. 210/473

(57) ABSTRACT

A fluid filter for use with a fluid having particulate material includes a housing having an internal surface having a set of depressions formed therein to trap particulate material in the fluid, and a filter media disposed in the housing to filter the fluid. In some embodiments, the fluid filter may be a transmission filter or an engine filter. In addition, a transmission system includes a transmission pan having an internal surface with a set of depressions formed therein, and a suction side transmission filter disposed in a transmission pan wherein the suction side transmission filter also has a filter housing having an internal surface with a set of depressions formed therein. Further, a magnet may be coupled to the depressions to aid in the capture and retention of ferromagnetic particles.

### CROSS-REFERENCE TO RELATED APPLICATIONS

This application claims priority to and is a continuation-in-part, of U.S. patent application entitled, INTEGRATED WAFFLE PAN APPARATUS AND METHOD filed Feb. 7, 2005 having a Ser. No. 11/050,867 now pending, the disclosure of which is hereby incorporated by reference in its entirety.

### FIELD OF THE INVENTION

The present invention relates generally to fluid filters in automotive vehicles. More particularly, the present invention relates to a transmission filter or engine filter for capturing contaminants.

### BACKGROUND OF THE INVENTION

An automotive transmission is a compressed hydraulic circuit whose primary purpose is to allow an engine to operate in a narrow RPM (revolutions per minute) while providing a wide range of output speeds. The transmission needs a fluid, typically a light oil to provide lubrication. As the fluid circulates through the transmission, the fluid collects damaging particulates which make it desirable to filter the fluid at a point prior to the circulation.

Commonly, fluid filtration takes place as the fluid is drawn back into the circulation from the sump or reservoirs. Existing filtration systems may have a number of disadvantages. For example, filtering small particulates as a fluid is drawn back into circulation may create a bottle neck effect that may lead to drops in fluid pressure. This is a particular concern during cold flow conditions.

The presence of large chips is a problem associated with fluid filtration. These chips may jam valves, plug oil packages and settle in places to become entrained in the oil after initial operation. A common approach to keeping these chips out of transmissions, fits each valve with an encapsulated screen so that chips cannot affect individual valves. However, this has not been very successful. The screens may become blocked with debris and prevent full fluid flow through the system, leading to costly repairs.

Accordingly, it is desirable to provide a simple and cost effective means to filter out the contaminant that settle on the bottom of a transmission or engine pan and prevent the clogging of the transmission filters. In addition to using filters to filter out the transmission oil, it is desirable to develop an apparatus and method that maximizes the settling and trapping phenomena of sediment in fluid housings, including transmissions and engines. Thus, it is desirable to provide a cost effective way to capture and contain sediment so that filters are kept free of clogs.

### SUMMARY OF THE INVENTION

The foregoing needs are met, to a great extent, by the present invention, wherein in one aspect an apparatus is provided that in some embodiments, takes advantage of the settling and trapping phenomena of sediment that naturally occurs due to gravity.

In some preferred embodiments of the invention, gravity brings debris particles to the bottom and magnets are utilized to further attract and capture ferromagnetic particles in the fluid, including transmission or engine fluid. Some embodiments include magnets at the lowest point, to increase contaminant collection and retention.

In accordance with one embodiment of the present invention, a fluid filter for use with a fluid having particulate material includes a housing having an internal surface having a set of depressions formed therein to trap particulate material in the fluid, and a filter media disposed in the housing to filter the fluid. In some embodiments, the fluid filter may be a transmission filter or an engine filter.

In accordance with another embodiment of the present invention, a transmission system includes a transmission pan having an internal surface with a set of depressions formed therein, and a suction side transmission filter disposed in a transmission pan wherein the suction side transmission filter comprises a filter housing having an internal surface with a set of depressions formed therein.

In accordance with another embodiment of the present invention, a method of capturing debris in a fluid filter includes passing fluid over a set of depressions formed in an internal surface of a housing, entrapping particles in the set of depressions, and passing fluid through a filter media.

In accordance with yet another embodiment of the present invention, an engine system includes an engine pan having an internal surface with a set of depressions formed therein, and a suction side engine filter disposed in an engine pan wherein the suction side engine filter comprises a filter housing having an internal surface with a set of depressions formed therein.

There has thus been outlined, rather broadly, certain embodiments of the invention in order that the detailed description herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a transmission pan according to a preferred embodiment of the invention.

FIG. 2 is a cutaway view of a transmission case.

FIG. 3 is a perspective view of the sheet-like insert according to another embodiment of the invention.

FIG. 4 is a perspective view of a fluid filter housing coupled to a magnet.

FIG. 5 is a perspective view of the fluid filter housing coupled to a magnet.

FIG. 6 is a plan view of the bottom of a fluid housing showing the grid.

FIG. 7 is a perspective view of an engine pan with a grid, coupled to a magnet.

FIG. 8 is a perspective view of a transmission pan coupled to a magnet.

### DETAILED DESCRIPTION

Embodiments of the present invention provide an apparatus that in some embodiments, takes advantage of the settling and trapping phenomena of sediment that naturally occurs due to gravity. A preferred embodiment includes a series of depressions or ribs forming a grid at the bottom of a fluid housing such as a transmission pan, looking somewhat like a “waffle iron” to attract, capture and retain debris as an additional manner of filtration. This allows the fluid filter to perform efficiently without the threat of the filter becoming clogged with larger debris. Thus, the series of depressions, or grid, acts as a “coarse flow” filter, allowing the suction side filter to act as a “fine flow” filter in that the filter filters fluid that has already had larger impurities removed.

Transmission or engine fluid often picks up debris, particulate material or impurities and this debris may jam valves or plug oil passages. The debris may also settle in places to become entrained in the oil after initial operation. As such, fluid filtration is desirable to ensure smooth operation of the transmission or engine.

A series of depressions or ribs forming a grid that looks like a “waffle iron” is formed, for example by stamping, at the bottom of the transmission pan or engine pan, such that when the fluid flows over the grid, contaminants settle on the bottom of the pan and are captured in the grid depressions. The grid may be formed for example, of upwardly extending ribs that create cavities between the ribs, or be formed with downwardly extending depressions.

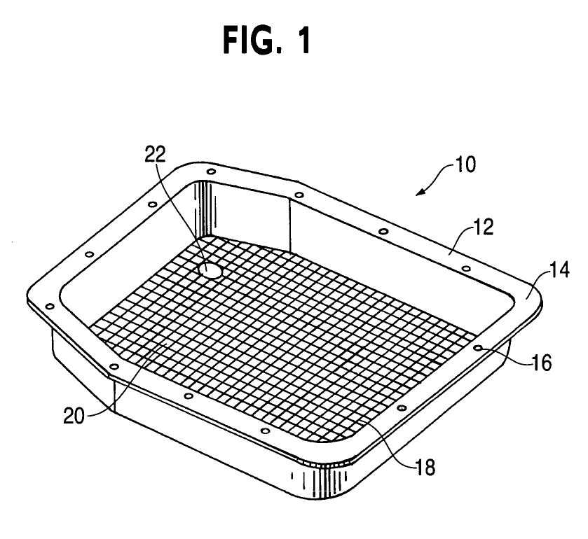

Embodiments of the invention will now be described with reference to the drawing figures, wherein like reference numerals denote like elements. FIG. 1 is a perspective view of a fluid housing 10, where a preferred embodiment of the present invention includes a transmission pan 12. Transmission pan 12 includes a transmission pan mounting flange 14, which contains openings 16 for mounting the transmission pan 12 to a transmission (not shown) using bolts. In addition, the transmission pan 12 has a transmission pan bottom 18 that has the series of ribs or depressions forming a grid 20 and a pan drain hole 22. In another preferred embodiment, the fluid housing 10 may also be an engine pan.

The transmission pan 12 with the grid 20, contains low flow stagnant oil locations that attract and hold debris better than pans or filters without the grid 20. The transmission pan 12 may easily be adapted to any manufacturers' transmission. There are typically two types of transmissions, one with a bottom pan and one with a split case, which lacks a bottom pan. An engine pan having the grid 20 formed therein may also be adapted to any manufacturer's engine.

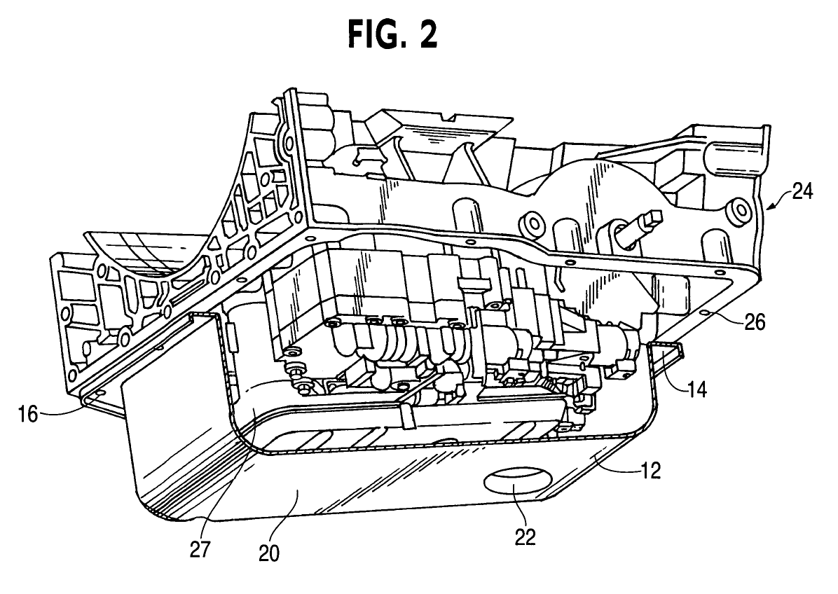

FIG. 2 is a cutaway view of a transmission case 24. The transmission case 24 includes openings 26 for mounting the transmission case 24 to the transmission pan mounting flange 14 at the pan's openings 16. The transmission pan 12 has a pan drain hole 22 at the transmission pan bottom 20. An engine pan having a grid 20 may be similarly configured to attach to an engine.

A fluid filter 27 may be disposed within the transmission pan 12 to filter fluid in the transmission. The transmission pan 12 may have a grid 20 formed therein. Similarly, an engine filter may be disposed within an engine. The fluid filter 27 may in turn be configured with a grid 20, as will be discussed further.

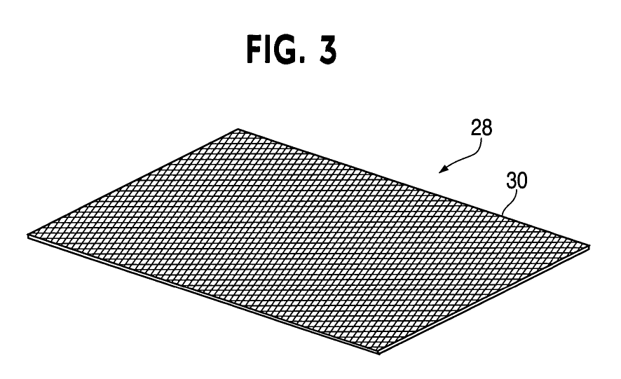

FIG. 3 is a perspective view of a sheet-like insert 28 according to another embodiment of the invention. The sheet-like insert 28 may then be placed inside any fluid housing including, a transmission pan or engine pan. The sheet-like insert 28 may be stamped with a series of depressions or ribs to form a grid 30 and then be placed inside a transmission pan or engine pan. This is particularly useful for placement of the sheet-like insert 28 in a split case transmission because a split case transmission lacks a bottom pan. The sheet-like insert 28 may be fashioned of a ceramic, a metal or a plastic material. The sheet-like insert 28 may also be coupled to a magnet or be formed from a magnetic material. Examples of a magnetic material include a molded ceramic.

For a split case transmission, the sheet-like insert 28 containing a series of depressions may be placed at the bottom, overlaying the split. A magnet may also be used to increase the attraction and retention of debris whereby the magnet may be coupled to the inside or the outside of the series of depressions or ribs.

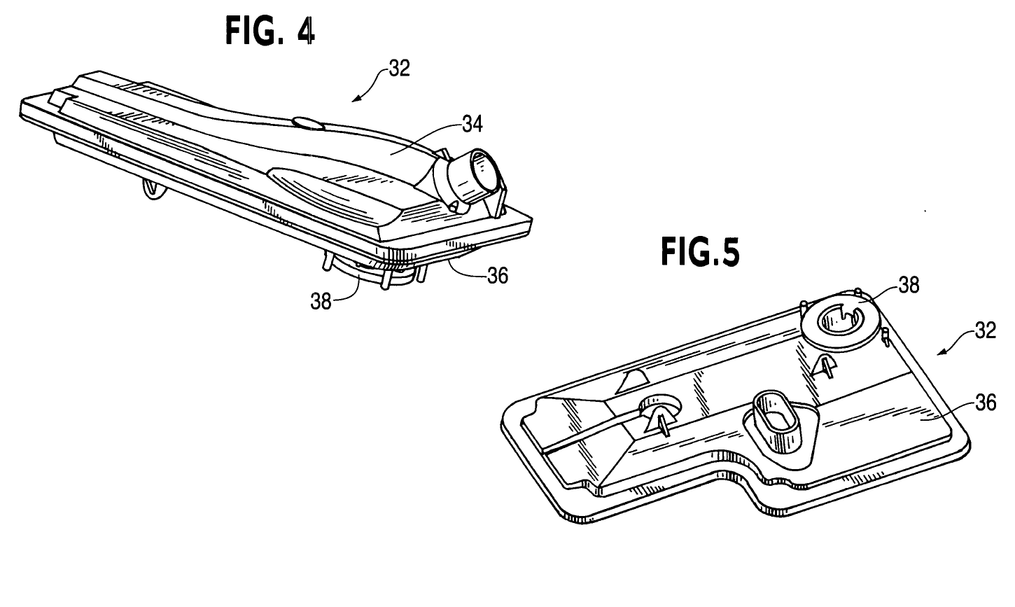

FIG. 4 is a perspective view of a fluid filter 32 coupled to a magnet. This fluid filter 32 is placed inside the transmission pan 12 or engine pan and filters the fluid. A filter 32 includes an upper housing 34, a lower housing 36 and a media insert (not shown) placed between the upper and lower components of the housing. The fluid enters the filter 32 and circulates through the media that removes debris or particulate material and exits from the filter to circulate through the transmission or engine. The fluid filter 32 may be a suction type filter or pressure type filter.

In another preferred embodiment of the present invention, the fluid housing is coupled to a magnet 38. The addition of the magnet 38 increases the capturing and retention of ferromagnetic particles. In an embodiment of the present invention, it is possible to stamp a magnetic sheet with a series of depressions or ribs and place the sheet inside the filter 32.

FIG. 5 is a perspective view of the bottom of the fluid filter 32 housing coupled to a magnet 38. Although the magnet 38 is shown coupled externally, the magnet 38 may readily be placed on an internal surface of the filter housing. In a preferred embodiment of the present invention, the magnet 38 is placed on the lower housing 36 to facilitate the settling and trapping phenomena of sediment that naturally occurs due to gravity. Further, the magnet 38 may be of any shape or size as can be seen by the illustrated circular magnet 38.

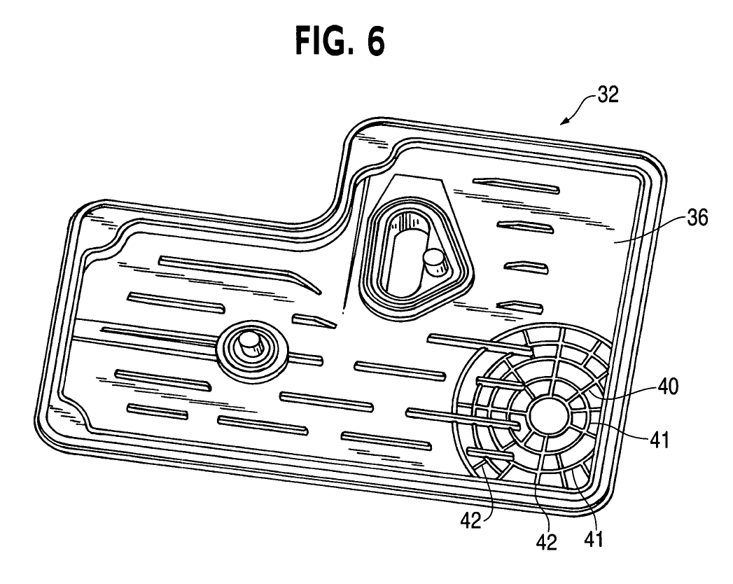

FIG. 6 is a plan view of a fluid housing showing the grid. In particular, this figure is a representation of the lower housing 36 of a suction side fluid filter 32 showing the grid 40. This figure further illustrates the varied nature of the grid 40 in that the grid 40 may be of any shape, size or pattern. The present illustration depicts a series of radiating circles 41 with additional ribs 42 placed at forty-five degree angles from each other. The ribs may be placed at any given angle as may be convenient.

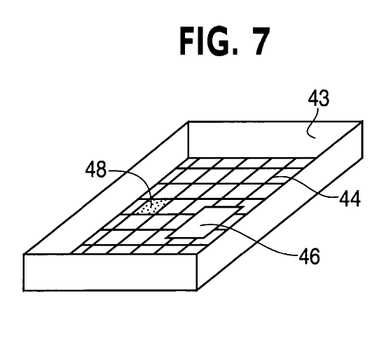

FIG. 7 is a perspective view of an engine pan 43 with a grid 44, coupled to a magnet 46. In addition, the figure also shows a magnet 46 coupled to the internal surface of the engine pan 43. The magnet 46 overlays the grid 44, covering a surface area of the grid, whereas a magnet 48 rests within the grid 44. Thus, the magnet 46 or 48 may alternately be a single sheet overlaying the series of depressions or may be a plurality of smaller magnets affixed into the grid 44.

Magnets may be used to capture ferromagnetic particles within the fluid flow. The magnets may be coupled to the inside or the outside of the fluid housing. Where the fluid housing is metallic, it is preferred that the magnet be placed inside the fluid housing. However, in the case of a non-metallic fluid housing, the magnet may be inside or outside the fluid housing. A magnetic sheet insert may also be formed of a magnetized material, and placed inside a fluid housing.

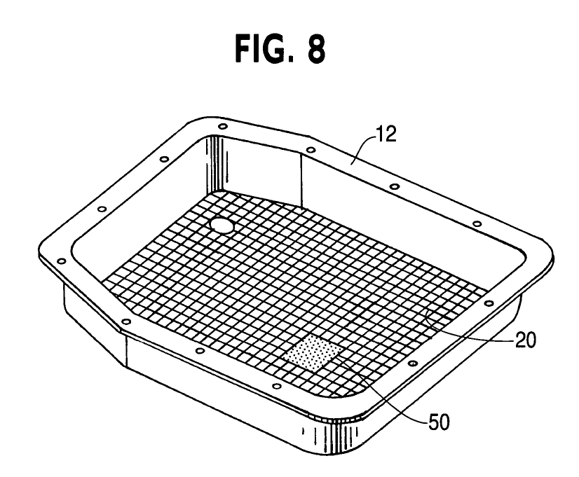

FIG. 8 is a perspective view of a transmission pan 12 coupled to a magnet 50. In particular the transmission pan 12 is configured on its internal surface with the grid 20. Although this figure shows the magnet 50 coupled to the internal surface, the magnet 50 may readily be coupled to the external surface of the transmission pan 12.

A preferred embodiment of the present invention includes stamping the transmission pan or engine pan to create a series of depressions. The series of depressions may be of any geometry or size. Shapes may also be a repeating series of rectangles, squares, circles or a radiating pattern of these geometries. There may be any number of depressions from one to greater than one. Also, rather than forming depressions, a series of upwardly extending ribs may be formed to capture debris. These ribs may also be of any geometry, size or a radiating pattern as discussed above.

The depressions or ribs in the transmission pan or engine pan are, in some embodiments placed at the bottom of the pan to allow the force of gravity to act on the impurities to allow them to fall into the grooves of the series of depressions or ribs. While the presently claimed invention relates to the transmission and engine of an automotive vehicle, this type of apparatus and method may be used with any device requiring fluid filtration.

The presently claimed invention has broad application, particularly in the automotive industry in that the series of depressions or grid, may be used with any transmission or engine. In addition, existing transmissions or engines may readily be adapted to contain the series of depressions or grid by way of retrofitting the transmission bottom pan or engine bottom pan.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A fluid filter for use with a fluid having particulate material comprising:
a housing having an internal surface having a set of depressions formed therein to trap particulate material in the fluid; and
a filter media disposed in the housing to filter the fluid.

2. The fluid filter of claim 1, wherein the set of depressions have a regular repeating geometry.

3. The fluid filter of claim 2, wherein the geometry of the set of depressions comprises a first plurality of parallel grooves.

4. The fluid filter of claim 1, wherein the set of depressions comprises a second plurality of parallel grooves at an angle to the first plurality.

5. The fluid filter of claim 1, wherein the fluid filter is a transmission filter.

6. The fluid filter of claim 1, wherein the fluid filter is an engine filter.

7. The fluid filter of claim 1, further comprising a magnet attached to the housing to attract the particulate material.

8. The fluid filter of claim 7, wherein the magnet is disposed on top of the set of depressions.

9. The fluid filter of claim 7, wherein the magnet is integral with the set of depressions.

10. The fluid filter of claim 7, wherein the magnet is coupled to the outside of the fluid filter housing.

11. The fluid filter of claim 1, wherein the internal surface comprises a sheet for placement in the fluid filter comprising:
a top surface having a series of depressions formed therein; and
a bottom surface adapted to attach the sheet to the internal surface of the fluid filter.

12. The sheet of claim 11, further comprising:
a magnet coupled to the sheet.

13. The sheet of claim 11, wherein the sheet is metallic.

14. The sheet of claim 11, wherein the sheet is plastic.

15. A transmission system comprising:
a transmission pan having an internal surface with a set of depressions formed therein; and
a suction side transmission filter disposed in a transmission pan wherein the suction side transmission filter comprises a filter housing having an internal surface with a set of depressions formed therein.

16. The transmission system of claim 15, wherein the set of depressions have a regular repeating geometry.

17. The transmission system of claim 15, wherein the geometry of the set of depressions comprises a first plurality of parallel grooves.

18. The transmission system of claim 15, wherein the set of depressions comprises a second plurality of parallel grooves of an angle to the first plurality.

19. The transmission system of claim 15, wherein a magnet is coupled to the set of depressions.

20. A method of capturing debris in a fluid filter comprising:
passing fluid over a set of depressions formed in an internal surface of a housing;
entrapping particles in the set of depressions; and
passing fluid through a filter media.

21. The method of claim 20, wherein the fluid filter is a transmission filter.

22. The method of claim 20, wherein the fluid filter is an engine filter.

23. The method of claim 20, wherein a magnet is coupled to the set of depressions.

24. A system for capturing debris in a fluid filter comprising:
means for defining a set of depressions in a bottom of the fluid filter; and
magnetic means for attracting particulates to the set of depressions.

25. The system of claim 24, wherein the fluid filter is a transmission filter.

26. The system of claim 24, wherein the fluid filter is an engine filter.

27. An engine system comprising:
an engine pan having an internal surface with a set of depressions formed therein; and
a suction side engine filter disposed in an engine pan wherein the suction side engine filter comprises a filter housing having an internal surface with a set of depressions formed therein.

28. The engine system of claim 27, wherein the set of depressions have a regular repeating geometry.

29. The engine system of claim 27, wherein the geometry of the set of depressions comprises a first plurality of parallel grooves.

30. The engine system of claim 27, wherein the set of depressions comprises a second plurality of parallel grooves of an angle to the first plurality.

31. The engine system of claim 27, wherein a magnet is coupled to the set of depressions.
